(19) United States
(12) Patent Application Publication
(10) Pub. No.: US 2017/0259311 A1
(43) Pub. Date: Sep. 14, 2017

(54) METHOD AND FACILITY FOR THE CONTINUOUS VITRIFICATION OF FIBROUS MATERIALS

(71) Applicant: PYRO GREEN INNOVATIONS, Anglet (FR)

(72) Inventors: Anne BENICHOU, Arsac (FR); Annie LAGOUTTE, Malves En Minervois (FR); Xavier MAURANCE, Anglet (FR); Jacques PROOT, Darlington, SC (US)

(21) Appl. No.: 15/510,132

(22) PCT Filed: Sep. 15, 2015
(86) PCT No.: PCT/FR2015/052460

§ 371 Date: Mar. 9, 2017

(30) Foreign Application Priority Data
Sep. 15, 2014 (FR) 1458625

(51) Int. Cl. B09B 3/00; F23D 14/32; F23G 5/08; F23D 14/22; C03B 5/00; C03B 5/235

(52) U.S. Cl. CPC B09B 3/0066; C03B 5/005; C03B 5/2356; B09B 3/005; F23G 5/085; F23D 14/22; F23D 14/32; C03B 2211/23; F23G 2202/20

(57) ABSTRACT

The present invention relates to a process and a facility for the continuous vitrification treatment of fibrous materials, and in particular of asbestos and/or of asbestos-containing materials.

According to the invention, this process comprises the following steps:
a bath of molten glass at a temperature of 1300° C. to 1600° C. is prepared;
introduced into said bath of molten glass are said fibrous materials and optionally melting additives chosen so that said bath has, after addition of these fibrous materials and melting additives, the following composition:
   SiO₂: between 30% and 55% by weight;
   FeO: between 25% and 45% by weight;
   alkali and alkaline-earth metal oxides: between 15% and 25% by weight;
an oxidizer and a fuel are injected under pressure into said molten bath by means of at least one lance, one end of which is immersed in said bath; said oxidizer being introduced in a molar amount greater than or equal to the molar amount of fuel needed to maintain the temperature of the bath between 1300° C. and 1600° C.; and
the temperature of at least one portion of the molten glass is lowered so as to render it solid.

The present invention relates generally to a process and a facility for the continuous vitrification treatment of fibrous materials, and in particular of asbestos and/or of asbestos-containing materials.

Within the context of the present description, a “fibrous material” is understood to mean any material formed partly or completely of fibers, that is to say of particles having a length to diameter ratio of greater than 3 and approximately parallel sides. Such a material may be composed of a single type of fiber or of a mixture of fibers that may or may not belong to the same class. These fibers may be mineral or organic fibers of natural or artificial origin.

The fibrous materials are in particular used in the field of construction and of thermal, electrical and/or sound insulation and are potentially dangerous to human health. Specifically, fibers having a diameter of less than 3 μm can penetrate into the pulmonary alveoli and thus be the cause of serious illnesnses.

In the description that will follow, reference will essentially be made to the treatment of materials comprising asbestos fibers which constitutes the main field of application of the present invention.

However, it will be understood that, generally, the invention may be applied to the treatment of other fibrous materials that are potentially dangerous to health, and more particularly materials comprising artificial mineral fibers such as, in particular, glass fibers, glass wool, rock fibers, rock and basalt wool, slag wool, refractory ceramic fibers, and generally any vitreous fiber or mixture of vitreous fibers.

The invention may also be applied to the treatment of crystalline artificial mineral fibers such as for example alumina fibers or potassium titanate fibers and also to metallic artificial mineral fibers such as in particular steel wool, copper wool, alone or as a mixture with fibrous materials comprising vitreous artificial mineral fibers as defined above.

It is known that, since Jan. 1, 1997, the use of asbestos has been banned in France but thousands of tonnes appear each year, originating from the demolition of old buildings or the decontamination thereof. Specifically, asbestos is dangerous due to its particular crystallization into long crystals that form fibers.

The technique known as landfilling constitutes a first solution that enables asbestos and waste containing same to be made safe.

This technique consists in permanently storing asbestos and asbestos-containing waste in compartments dug in the ground and covered with a watertight material, the whole assembly being combined with a system for draining the leachates.

Although strictly supervised at the regulatory level, and relatively inexpensive, this technique is not however entirely satisfactory for obvious environmental reasons.

Much research has therefore been carried out with the aim of developing a process that makes it possible to treat waste containing asbestos, in particular the waste generated by asbestos-removal works in civil engineering or the operations for demolition of various fittings made from materials containing asbestos.

Within this context, an inerting process by plasma melting has in particular been proposed in document WO 2008/065031, via which process asbestos-containing materials are brought to a very high temperature by blowing air over an electric arc inside a torch, in order to generate an ionized gas similar to a flame, the temperature of which may locally be several thousands of degrees.

This process, which is currently the subject of industrial exploitation, is however very expensive due to a very high energy consumption and the use of a high-technology plasma torch that requires expensive maintenance.

Thus, due to this high cost, the use of this method today remains limited.

Other processes requiring a high-frequency generator, or the addition of fluxes such as Borax, or else an acid treatment of the asbestos have been proposed, but none of these alternative processes is entirely satisfactory from an industrial point of view.

Under these conditions, the objective of the present invention is to solve the technical problem consisting of the provision of a novel process for the continuous vitrification of fibrous materials, in particular of asbestos and/or of asbestos-containing materials, the implementation cost of which, on the industrial scale, is substantially lower than that of the currently used vitrification process that uses a plasma torch.

Thus, according to a first aspect, thee subject of the present invention is a process for the continuous vitrification of fibrous materials, in particular of asbestos and/or of asbestos-containing materials, characterized in that it comprises the following steps:

a bath of molten glass at a temperature of 1300° C. to 1600° C. is prepared;

introduced into said bath of molten glass are said fibrous materials and optionally melting additives chosen so that said bath has, after addition of these fibrous materials and melting additives, the following composition:
SiO₂: between 30% and 55% by weight;
FeO: between 25% and 45% by weight;
alkali and alkaline-earth metal oxides: between 15% and 25% by weight;

an oxidizer and a fuel are injected under pressure into said molten bath by means of at least one lance, one end of which is immersed in said bath; said oxidizer being introduced in a molar amount greater than or equal to the molar amount of fuel needed to maintain the temperature of the bath between 1300° C. and 1600° C.; and

the temperature of at least one portion of the molten glass is lowered so as to render it solid.

Thus it has been discovered, and this constitutes the basis of the present invention, that fibrous compounds, and in particular asbestos-containing compounds, could be treated by vitrification in a furnace equipped with at least one lance making it possible to inject, into a molten glass laden with fibrous materials, a pressurized mixture of an oxidizer and of a fuel, under neutral or slightly oxidizing conditions, i.e. under conditions where the oxidizer is introduced in a molar amount greater than or equal to the molar amount of fuel needed to maintain the temperature of the bath between 1300° C. and 1600° C. and to thus obtain an amorphous vitrified material that incorporates said materials.

The use of a furnace equipped with a lance has already been described in patent EP 1 235 889.

However, in the case of this prior patent, this furnace was used for the gasification of carbon-based compounds such as wood, under reducing conditions, i.e. in the presence of an insufficient amount of oxidizer (oxygen) to enable the combustion of said carbon-based compounds, in order to produce a combustible syngas.

Such a gasification process operating under reducing conditions cannot be used within the context of the vitrification of asbestos.

Within the context of the present description, the term “glass” is understood to mean any amorphous inorganic material produced by melting that solidifies without crystallizing comprising:

silicate oxides and in particular silica (SiO₂);

alkali metal oxides, in particular Na₂O, K₂O, Li₂O, or alkaline-earth metal oxides (CaO, BaO, MgO); and

oxides of elements such as aluminum, iron, titanium and zinc.

Within the context of the present description, the term “asbestos” is used in its most general acceptance and covers hydrated silicates of rocky origin that are mechanically treated and in particular the asbestoses of serpentine type such as for example chrysotile, the only crystalline variety, and the asbestoses of amphibole type, of which there are five, including blue asbestos, crocidolite.

As is understood, the novelty of the process in accordance with the invention lies in the fact that it makes it possible to inert the fibrous materials, due to the melting thereof in a glass bath under conditions such that the glass obtained after addition of said fibrous materials and of selected melting additives has substantially the same composition as the initial glass, so that these fibrous materials, after treatment, no longer present any danger, in particular to health. In other words, the process in accordance with the invention aims not only to encapsulate the fibrous materials in glass, but to dissolve them completely by melting under conditions such that these materials become an integral part and components of this glass.

The use of an oxidizer/fuel mixture enabling the vitrification of the fibrous compounds and of the melting additives under neutral or slightly oxidizing conditions makes it possible, in addition, to achieve an effective treatment of the fibrous compounds with a reasonable cost.

Under this aspect, the process in accordance with the invention makes it possible to recover the residual energy of the furnace (in particular the thermal energy of the gases) for the production of electricity. Unlike the process using a plasma torch and consequently, very expensive energy, electricity, the process in accordance with the invention uses gas, which is much less expensive and can, in addition, generate electricity by the use of the residual heat at the outlet of the furnace.

According to one particular feature of the process according to the invention, the aforementioned oxidizer and fuel are injected into said bath of molten glass under a pressure of between 1.2 and 10 atmospheres, preferably of between 3 and 6 atmospheres.

According to another particular feature of this process, the aforementioned oxidizer is introduced into the bath in a molar amount of between 1 and 1.2 times the molar amount of fuel.

Advantageously, the aforementioned melting additives are selected from silica, iron oxide, consumer residues (municipal waste) or iron-rich incineration residues, such as for example fine scrap iron, or even cans.

As is understood, these additives are selected in order to obtain a mixture to be treated that has a predetermined composition, that of a glass, and that guarantees the complete dissolving of the fibrous compounds in the molten bath.

According to another particular feature of the process according to the invention, the aforementioned oxidizer is selected from air or oxygen-enriched air, for example enriched air containing 35% of oxygen.

Generally, a person skilled in the art will understand that if oxygen-enriched air is used, the fuel consumption will be reduced or, at equal consumption, the temperature obtained will be higher.

According to another particular feature of the process according to the invention, the fuel is selected from natural gas and fuel oil.

A portion of this fuel may optionally be replaced by carbon-based materials present in the fibrous compounds such as for example in the polyester present in the glass fiber/polyester composites capable of being treated by the process in accordance with the invention.

A portion of this fuel may also optionally be replaced by organic residues originating for example from wood, plastics or municipal waste.

It should be noted that some of the melting additives added within the context of the process according to the invention will make it possible to reduce the amount of fuel used. For example, in the case of treating asbestos, a supply of iron in the form of fine scrap may be envisaged. The heat of oxidation of the iron will make it possible to reduce the amount of fuel injected. Since the oxygen consumption hardly decreases, the iron may therefore be considered in this case to be a fuel.

According to a second aspect, the present application aims to cover a facility for the continuous vitrification of fibrous materials, in particular of asbestos and/or of asbestos-containing materials, characterized in that it comprises:

means for containing a bath of molten glass;

means for loading said fibrous compounds into said bath of molten glass;

optional means for loading melting additives;

means for injecting an oxidizer and a fuel under pressure into said molten bath by means of at least one lance, one end of which is immersed in said bath;

means for recovering the hot gases resulting from the vitrification; and

means for lowering the temperature of at least one portion of the molten glass incorporating the fibrous materials and melting additives, so as to render it solid.

According to one particular feature of this facility, the means for containing the bath of molten glass consist of a vertical cylindrical enclosure comprising, in its upper portion, an opening enabling the loading of said fibrous materials; one or more openings enabling the passage of one or more lances; and, in its lower portion, at least one opening enabling at least one portion of the molten glass to be drawn off.

According to another particular feature of this facility, the openings enabling the passage of one or more lances are made in the wall delimiting the upper portion of said enclosure.

According to yet another particular feature of this facility, the opening enabling the loading of the fibrous materials is made in the wall delimiting the upper portion of said enclosure.

Other features and advantages of the invention will emerge on reading the explanatory description that follows and the example given nonlimitingly, with reference to the appended drawings in which:

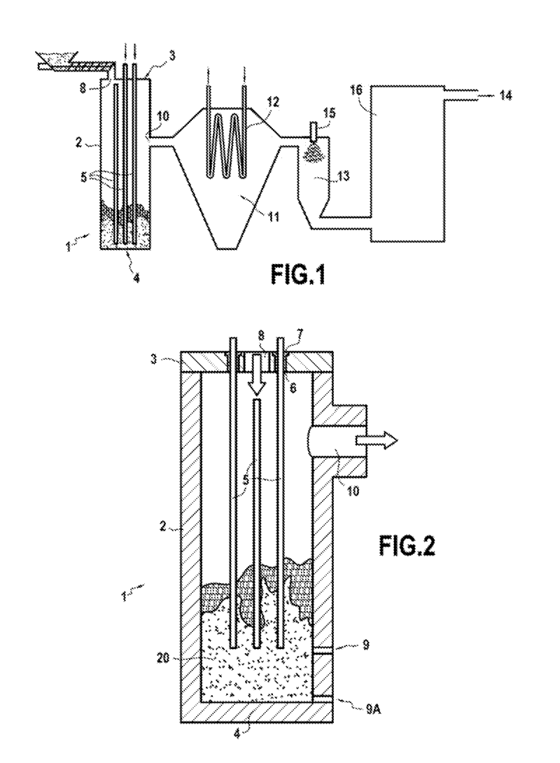

FIG. 1 is a general schematic view of a facility for the vitrification of fibrous compounds according to the invention;

FIG. 2 is a cross-sectional view of one embodiment of a furnace used in the aforementioned facility.

Represented schematically in FIG. 1 is a facility for the continuous vitrification of fibrous materials according to the invention.

This facility essentially comprises an enclosure or furnace 1, represented in greater detail in FIG. 2.

This furnace 1 consists of a side wall 2, an upper wall 3 and a lower wall 4 delimiting, in the embodiment represented, a vertical cylindrical enclosure, the height of which is greater than the diameter.

This enclosure may nevertheless have any other shape, such as for example an ovoid or elliptical shape.

The walls 2, 3, 4 are generally formed, at least on their face constituting the inner surface of the enclosure intended to be in contact with the bath of molten glass, from a refractory material formed for example of alumina or chrome-magnesia.

The furnace 1 may have various dimensions, which dimensions depend, as is understood, on the amounts of fibrous materials to be treated.

By way of example, the diameter of such a furnace will generally be greater than 3 m and its height between 6 and 12 m.

In the example represented in FIG. 2, the side wall 2 is formed from a single part.

Alternatively, the furnace 1 may consist of several, advantageously three, vertically superposed elements joined together in a leaktight manner by clamps. Such an assembly allows an easy replacement of any section of the side wall that has undergone a degradation, said section being able to be repaired in a workshop before being reused.

In the example represented in FIG. 2, the upper wall 3 of the furnace 1 comprises, for each lance 5, an opening 6 enabling the passage and the displacement of said lance, said opening 6 being provided with sealing means 7 consisting for example of mechanical seals or rubber sleeves.

The number of lances 5 will depend on the capacity of the furnace 1 and will generally be between 1 and 5. Advantageously, the furnace 2 will be equipped with three lances 5, as represented in FIG. 2, positioned for example in a triangle in order to enable an agitation of the bath of molten glass.

Moreover, the use of a plurality of lances favors a more homogeneous upward movement of the combustion gases and makes it possible, if necessary, to replace one lance without interrupting the production in progress.

Alternatively, each lance passage opening may be made in the upper portion of the side wall 2 of the furnace 1, a combination of openings in the upper wall 3 and in the side wall 2 of the furnace 1 also being possible in the case of a furnace equipped with several lances.

Each lance 5 generally consists of a hollow outer cylindrical tube formed from a steel alloy and intended to transport the oxidizer (air or oxygen). As the furnace operates with neutral or oxidizing melting, an inner cylindrical tube is positioned inside the outer tube, preferably coaxially, in order to transport the fuel (gas or fuel oil). This inner cylindrical tube is slightly shorter than the outer tube.

Each lance 5 has a length adapted to the length of the furnace and an inner surface such that the oxidizer and the fuel pass across it with an acceptable velocity (between 10 and 30 m/s).

Each lance 5 has a first end connected to a device (not represented) for supplying pressurized oxidizer/fuel, for example through a flexible pipe, and a second end where the pressurized mixture burns and delivers a flame, this second end being intended to be immersed in the bath of molten glass during the implementation of the process according to the invention.

The upper wall 3 of the furnace 1 is also provided with an opening 8 that enables the loading of the fibrous materials, this opening 8 also being provided with sealing means such as an airlock (not represented). As is understood, this arrangement enables the loading of the fibrous materials directly above the bath of molten glass.

Alternatively, this opening for loading the fibrous materials may be positioned in the upper portion of the side wall 2.

Alternatively again, the opening 8 or a second opening for loading the fibrous materials may be provided in communication, for example by means of an endless screw, with a hopper mounted on the outside of the furnace 1 (see FIG. 1).

Advantageously, this endless screw is hermetically connected to the furnace and provided with a heating system.

The furnace 1 also comprises an opening 10 made in its side wall 2, preferably located at two thirds of the height of the furnace starting from the lower wall 4, enabling the venting of the gases generated in the furnace 1 during the vitrification.

This opening 10 communicates with a chamber 11 equipped with a heat exchanger 12 enabling the at least partial recovery of the heat energy of said gases and consequently an optimization of the energy efficiency of the facility.

The heat exchanger 12 may consist, of a coil in which a heat, transfer fluid, intended to supply a turbine (not represented), flows. This fluid may be water that will give steam or preferably compressed air, which will therefore undergo a thermal expansion that makes it possible to drive the turbine.

The chamber 11 is connected to a purification device 13 capable of eliminating the possible traces of dust and of providing a clean gas at the outlet 14.

The purification device 13 is generally equipped with a powder injector 15—in particular an injector of sodium carbonate or bicarbonate—intended to capture the major gaseous impurities (chlorine and sulfur), followed by an air filter 16.

In order to avoid any escape of flue gas, a variable speed exhaust fan, controlled by the pressure at the top of the furnace 1, which will have to be zero with respect to the atmosphere, will be provided at the end of the circuit, after the purification device.

The furnace 1 also comprises, in the lower portion of the side wall 2, an opening 9 that leads into a reservoir or forehearth (not represented), adjacent to the lower portion of the furnace 1, and that makes it possible to draw off a portion of the molten glass formed after addition of the fibrous materials and optional melting additives, and to lower the temperature thereof so as to render it solid.

By way of example, the opening 9 for casting the molten glass is generally positioned at a height of 50 centimeters (measured starting from the bottom 4 of the furnace 1).

The reservoir or forehearth, of known design, is open in its upper portion and delimited by a wall, the upper edge of which is substantially above the average level of the bath of molten glass in the furnace 1. As is understood, the molten glass flows through the aforementioned opening 9 in order to fill the reservoir up to a height substantially equal to that of the molten glass in the furnace.

The upper portion of the wall of this reservoir comprises a channel that may be blocked off, in particular by day, between two successive castings. This channel blocked off in this way may be pierced mechanically or thermally (by means of a steel pipe supplied with oxygen and that will burn at its end).

The furnace 1 may also comprise, at its bottom 4, an opening 9A (blocked off when in operation) that makes it possible in particular to empty the furnace for the maintenance thereof.

With reference to FIG. 1, the various steps of the process in accordance with the invention will now be described.

In order to prepare a bath of molten glass, the empty furnace 1 is carefully preheated to avoid giving rise to a thermal shock of the refractory material constituting the inner wall of the furnace 1. This preheating may be carried out using one or more lances 5, and/or with the aid of a secondary burner (not represented) that is dropped into the furnace at the end of a cable. This operation may require around 2 to 3 hours.

When the temperature inside the furnace is around 1400° C., glass, preferably originating from a vitrified material granulated during a previous casting, is introduced in successive portions.

During this step, the temperature is maintained at around 1400° C. by means of one or more lances 5 delivering a flame originating from the combustion of a mixture of air, oxygen-enriched air or oxygen and gas or fuel oil. When the level of molten glass in the furnace is sufficient (for example when the level of the molten glass reaches a height of around 30 to 50 cm inside the furnace), the lance(s) is(are) immersed in the bath of molten glass 20 in order to maintain the temperature of 1400° C. This operation may require around 3 to 4 hours.

The fibrous materials are then introduced (in successive portions) through the opening 8 taking care to avoid excessively high temperature variations in the molten glass.

Some fibrous materials (other than asbestos) may be in pulverulent form. In this case, it is advisable to amalgamate them with another material such as for example bitumen via the endless screw before their introduction into the furnace. If it is a question of large and regular amounts, at least one lance may be modified in order to inject this powder with air into the bath.

Simultaneously or separately, the optional melting additives, such as in particular silica, iron or iron oxide in the case of asbestos-containing materials, are introduced into the bath of molten glass, preferably through the opening 8 and the optional airlock.

The amount of fibrous materials, and the amount and nature of the melting additives are predetermined, so that, after addition of these materials, the mixture obtained has a composition that is generally identical or very similar to the composition of the initial glass, and that corresponds to the following definition:

SiO₂: between 30% and 55% by weight;

FeO: between 25% and 45% by weight;

alkali and alkaline-earth metal oxides: between 15% and 25% by weight.

Thus, in particular in the case of asbestos, the melting additives will modify the composition of the feedstock to be treated and will guide it to the ideal melting zone.

According to one particular embodiment, glass may be added, preferably simultaneously, to the aforementioned fibrous materials and to the aforementioned melting additives.

When the addition of the fibrous materials and of the melting additives is finished (the glass having reached a level of around 1.5 to 2 meters above the casting opening 9), the bath is still kept molten for a duration of several minutes in order to ensure the homogeneity thereof. Each lance is then withdrawn from the bath while being kept in operation just above the bath in order to maintain the temperature inside the furnace and avoid the agitation of the bath during the casting.

A “casting” operation is then carried out that makes it possible to draw off at least one portion of the molten glass, to cool it and to process it for example in granulated form.

For this purpose, the opening 9 of the furnace 1 leading to the molten glass sampling reservoir is pierced to allow the casting of molten glass in the reservoir. This piercing of the opening 9 may be carried out mechanically using a chisel or thermally using a blowtorch. At the end of the casting, the opening 9 is blocked up again, for example using clay.

The glass may thus be drawn off in portions at regular intervals or alternatively continuously.

Preferably, all the molten glass that is above the opening 9 will be cast in one go.

The glass drawn off is then solidified as quickly as possible in order to guarantee its stability and is advantageously granulated in order to be used for example as aggregate for road engineering, for the manufacture of paving or as sandblasting agent. The initial fibrous materials are thus entirely dissolved in the molten glass and perfectly inert, their crystalline structure which was dangerous having (in particular in the case of asbestos) completely changed and any trace of fibers having disappeared.

Two methods may be envisaged in order to solidify the molten glass drawn off from the furnace.

A first method consists in allowing the glass to flow into a channel transporting a strong current of water, thus obtaining a sand.

Alternatively, the glass may be cast in a water tank by letting it drop from a height of around 3 meters, in such a way that the glass can acquire a velocity sufficient to penetrate the water without shattering at the surface. Thus grains having a diameter of 15 to 30 millimeters are obtained.

The operation which has just been described may be repeated by again loading predetermined amounts of fibrous compounds and melting additives and optionally glass into the bath of molten glass remaining in the furnace.

The gases directly resulting from the vitrification reaction of the fibrous compounds are hot and, according to one particular feature of the process in accordance with the invention, the heat energy of these gases is recovered by transfer to a heat transfer fluid (which may be water or preferably compressed air) capable of driving a turbine.

More specifically, during the vitrification process, an upward gas flow occurs inside the furnace 1 and escapes through the opening 10 in order to enter the chamber 11.

The gases, the temperature of which is generally of the order of 1500° C., are cooled in contact with the heat exchanger 12.

When the gases reach a temperature of around 200° C., the efficiency of the heat exchanger 12 becomes relatively mediocre and the gases are discharged.

They are conveyed through the opening 10 to the purification device 13 in which the last traces of dust are eliminated, thus supplying a clean gas at the outlet 14.

The following examples will illustrate the invention.

### EXAMPLE 1

### Destruction Of Asbestos Cement

Asbestos cement is one of the most difficult materials to destroy given the high content of calcium and magnesium oxides that it contains.

This asbestos is dangerous due to its particular crystallization into fibers that were formed at great depth under enormous pressures and relatively moderate temperatures.

The process in accordance with the invention makes it possible, in particular by the addition of silica and iron oxide or iron, to dilute these alkaline-earth metal oxides and melt them at a moderate temperature, thus inerting the asbestos.

### EXAMPLE 1A

### a) Preparation of a Bath of Molten Glass

In this example, use was made of a furnace with a diameter of 3 meters and a height of 8 meters as described above.

This vacuum furnace was preheated for a duration of around 2 hours to a temperature of around 1400° C., by means of an auxiliary burner dropped into the furnace at the end of a cable.

When the temperature inside the furnace reached around 1400° C., glass originating from a vitrified material granulated during a previous casting was slowly introduced.

During this step, the temperature is maintained at around 1400° C. by means of 3 lances delivering a flame originating from the combustion of a mixture of air and natural gas, in an O₂/gas stoichiometric ratio of 1.1:1.

When the level of molten glass inside the furnace reached a height of 50 cm, the 3 lances were immersed in the bath of molten glass in order to maintain a temperature of 1400° C. The flames submerged in the glass bath give the process an excellent efficiency.

### b) Introduction of the Fibrous Compounds

In this example, use was made of an asbestos cement based on asbestos (chrysotile) containing around 50% by weight of CaO and 8% by weight of SiO₂, and also minor elements such as MgO, Al₂O₃, etc., the remainder to 100% essentially consisting of water of hydration or water of crystallization.

Added to 1 tonne of this asbestos cement were 532 kg of silica and 913 kg of equivalent FeO.

This mixture is produced by successive additions into an airlock for introducing the fibrous compounds.

This mixture is introduced into the furnace in an amount of 100 kg/min during each opening of the airlock.

After 4 hours, the level in the furnace reached 1.8 m and the molten glass obtained has the following composition:

SiO₂: 30% by weight;

FeO: 44% by weight;

alkali and alkaline-earth metal oxides: 25% by weight;

aluminum oxide: 0.5% by weight;

minor components: 0.5% by weight.

The 3 lances were then removed in order to stop the agitation of the glass while maintaining the temperature of the bath for a duration of around 10 minutes.

The opening for casting the glass was then pierced and around 20 tonnes of glass were drawn off, leaving a molten glass bath base with a height of around 50 cm in the furnace.

The glass thus drawn off had the same composition as the initial glass, the fibrous materials having been completely dissolved therein and no longer presenting any danger.
c) The Gases were Cooled in a Heat Exchanger in Order to Recover the Energy therefrom and Produce Electricity Before Being Purified.

Under the reaction conditions described, the gas consumption was 1409 Nm³/h.

The heat exchanger enabled the recovery of 7805 Mcal/h, i.e. 9.1 MWₜₕ.

### EXAMPLE 1B

Example 1A was reproduced using, as oxidizer, enriched air containing 35% of oxygen.

In this case, the gas consumption was 711 Nm³/h and the energy recovered 2531 Mcal/h, i.e. 2.95 MWₜₕ.

As is understood, the oxygen content in the air supplying the lances may be adjusted in order to optimize the power at the turbine.

### EXAMPLE 1C

Example 1B was reproduced, replacing the iron oxide with fine scrap iron originating for example from cans.

In this case, for 1 tonne of asbestos cement, 710 kg of fine scrap iron were used.

The amount of gas needed for the combustion was 446 Nm³/h, lower than the amount used in example 1A.

On the other hand, the heat available at the exchanger was only 765 Mcal/h, i.e. 0.9 MWₜₕ.

In this example, the oxygen consumption was 576 Nm³/h.

### EXAMPLE 2

### E-Glass Fibers

These fibers, classified as dangerous, are also difficult to treat due to their relatively high content of alkaline-earth metal oxides and alumina.

### a) Preparation of a Bath of Molten Glass

By following the procedure of example 1a), a bath of molten glass originating from a vitrified material granulated during a previous casting was prepared.

In this example, the temperature during the vitrification was maintained at around 1400° C.

### b) Introduction of the Fibrous Compounds

In this example, glass fiber/polyester composites containing around 22% of fibers were used.

The average composition of the composites to be treated was the following:

SiO₂: 56% by weight;

B₂O₃: 7% by weight;

Al₂O₃: 14.5% by weight;

MgO: 3% by weight;

CaO: 18.5% by weight;

minor compounds: 1% by weight.

94.6 kg of iron oxide was added to 1 tonne of these composites.

The glass obtained had the following composition, identical to that of the initial glass:

SiO₂: 40% by weight;

FeO: 30% by weight;

alkali and alkaline-earth metal oxides (CaO, MgO): 14% by weight;

aluminum oxide (Al₂O₃): 10% by weight;

boron oxide (B₂O₃): 5% by weight;

minor compounds: 1% by weight.

1. A process for the continuous vitrification of fibrous materials, which comprises the following steps:
preparing a bath of molten glass at a temperature of 1300° C. to 1600° C.;
introducing into said bath of molten glass said fibrous materials with or without melting additives chosen so that said bath has, after addition of these fibrous materials and melting additives, the following composition:
SiO₂: between 30% and 55% by weight;
FeO: between 25% and 45% by weight;
alkali and alkaline-earth metal oxides: between 15% and 25% by weight;
injecting under pressure an oxidizer and a fuel into said molten bath, said injection being carried out by means of at least one lance, one end of which is immersed in said bath; said oxidizer being introduced in a molar amount greater than or equal to the molar amount of fuel needed to maintain the temperature of the bath between 1300° C. and 1600° C.; and
lowering the temperature of at least one portion of the molten glass so as to render it solid.

2. The process as claimed in claim 1, wherein the aforementioned oxidizer and fuel are injected into said bath of molten glass under a pressure of between 1.2 and 10 atmospheres.

3. The process as claimed in claim 1, wherein the aforementioned oxidizer is introduced into the bath in a molar amount of between 1 and 1.2 times the molar amount of fuel.

4. The process as claimed in claim 1, wherein the aforementioned melting additives are selected from the group consisting of silica, iron oxide, consumer residues (municipal waste) and iron-rich incineration residues.

5. The process as claimed in claim 1, wherein the aforementioned oxidizer is selected from the group consisting of air and oxygen-enriched air.

6. The process as claimed in claim 1, wherein the fuel is selected from natural gas and fuel oil.

7. The process as claimed in claim 1, which is carried out in a facility comprising:
means for containing a bath of molten glass;
means for loading said fibrous compounds into said bath of molten glass;
optional means for loading melting additives;
means for injecting an oxidizer and a fuel under pressure into said molten bath by means of at least one lance, one end of which is immersed in said bath;
means for lowering the temperature of at least one portion of the molten glass incorporating the fibrous materials and melting additives, so as to render it solid.

8. The process as claimed in claim 7, wherein the means for containing the bath of molten glass consist of a vertical cylindrical enclosure comprising, in its upper portion, an opening enabling the loading of said fibrous materials; one or more openings enabling the passage of one or more lances; and, in its lower portion, at least one opening enabling at least one portion of the molten glass to be drawn off.

9. The process as claimed in claim 8, wherein the openings enabling the passage of one or more lances are made in the wall delimiting the upper portion of said enclosure.

10. The process as claimed in claim 9, wherein the opening enabling the loading of the fibrous materials is made in the wall delimiting the upper portion of said enclosure.

11. The process as claimed in claim 2, wherein oxidizer and fuel are injected into said bath of molten glass under a pressure of between 3 and 6 atmospheres.

12. The process as claims in claim 1, wherein said fibrous materials are selected from the group consisting of asbestos and asbestos containing materials.

13. The process as claimed in claim 1 wherein the aforementioned oxidizer is oxygen-enriched air containing 35% of oxygen.

14. The process as claimed in claim 1, wherein hot gases resulting from the vitrification are recovered and wherein it is carried out in a facility comprising:
means for containing a both of molten glass;
means for loading said fibrous compounds into said bath of molten glass;
optional means for loading melting additives;
means for injecting an oxidizer and a fuel under pressure into said molten bath by means of at least one lance, one end of which is immersed in said bath;
means for recovering the hot gases resulting from the vitrification; and
means for lowering the temperature of at least one portion of the molten glass incorporating the fibrous materials and melting additives, so as to render it solid.
